(19) United States
(12) Patent Application Publication
(10) Pub. No.: US 2010/0050106 A1
(43) Pub. Date: Feb. 25, 2010

(54) LEVEL ADJUSTING DEVICE, SIGNAL PROCESSOR, AV PROCESSOR AND PROGRAM

(75) Inventors: Shinya Koizumi, Kawasaki-Shi (JP); Toru Ebata, Kawasaki-shi (JP)

Correspondence Address: YOUNG & THOMPSON, 209 Madison Street, Suite 500, Alexandria, VA, 22314, US

(73) Assignee: PIONEER CORPORATION, TOKYO (JP)

(21) Appl. No.: 12/530,492

(22) PCT Filed: Mar. 9, 2007
(86) PCT No.: PCT/JP2007/000193

§ 371 Date: Oct. 5, 2009

(51) Int. Cl. G06F 3/048

(52) U.S. Cl. 715/771

(57) ABSTRACT

Provided herein is an AV processing apparatus which displays through a GUI a fader F capable of adjusting an output level by moving an operation element along a predetermined track on a touch panel TP. When an arbitrary position on the track is designated as a point by an operation of a user, the operation element is moved at a constant speed over a predetermined required moving time from a moving start position which is a position of the operation element before the designation to the designated arbitrary position.

### TECHNICAL FIELD

The present invention relates to a level adjustment apparatus which can adjust an output levels with an operation member such as a fader or a knob, a signal processing apparatus, an AV processing apparatus and a program therefor.

### BACKGROUND ART

In recent years, there has been known a PC application for implementing an audio mixer in a computer (for example, Patent Document 1). In this kind of PC application, an operation member such as a fader is displayed through a GUI on a display and output levels (parameters) of various musical components such as sound volume or an assignment rate of an audio effect can be adjusted by moving (dragging) an operation element of the operation member with a pointing device such as a mouse by a user.

### [Patent Document 1] JP-A-2000-040345

### DISCLOSURE OF THE INVENTION

### Problems to be Solved

However, it is not possible to operate intuitively in comparison with a case in which an operation member disposed physically is operated, because the operation member needs to be operated with a mouse or the like in the above PC application. Generally, an audio mixer and the like is likely to be adapted to DJ equipment (equipment used for audio performance by disc jockeys (DJ)). As the audio mixer provided as the PC application is inferior in operability as described above, it is difficult to adapt it in equipment desired with various operations such as the DJ equipment.

On the other hand, in a case that an operation member is disposed physically, though it is possible to acquire an operational feeling, a moving speed varies because the user performs an operation by moving the operation member with the user's finger, leading to inconvenience of the mechanical operation member such that output levels can not be increased or decreased at a constant rate.

It is an advantage of the invention to provide a level adjustment apparatus which can perform with an intuitive operation adjustments of an output levels, which can not be achieved with the mechanical operation member, a level adjustment apparatus, a signal processing apparatus, an AV processing apparatus and a program therefor.

### Means to Solve the Problems

According to one aspect of the invention, there is provided a level adjustment apparatus having: a display unit which displays through a GUT an operation member capable of adjusting an output level by moving an operation element along a predetermined track on a touch panel having a display function; an operation unit which operates the operation element with the touch panel having the display function; a display control unit which performs a display control of the display unit based on an operation of the operation unit; and a level control unit which controls the output level so as to change the output level at a constant rate based on a position of the operation element displayed on the display unit with the display control of the display control unit. When an arbitrary position on the track is designated by the operation unit as a point, the display control unit moves the operation element at a constant speed from a moving start position which is a position of the operation element before the designation to the designated arbitrary position over a predetermined required moving time.

In the level adjustment apparatus described above, it is preferable that the apparatus further have a required moving time setting unit which sets the required moving time, and the display control unit move the operation element from the moving start position to the arbitrary position over the required moving time set by the required moving time setting unit.

Another level adjustment apparatus of the invention has: a display unit which displays through a GUI an operation member capable of adjusting an output level by moving an operation element along a predetermined track on a touch panel having a display function; an operation unit which operates the operation element with the touch panel having the display function; a display control unit which performs a display control of the display unit based on an operation of the operation unit; and a level control unit which controls the output level so as to change the output level at a constant rate based on a position of the operation element displayed on the display unit with the display control of the display control unit. When an arbitrary position on the track is designated by the operation unit as a point and is released, the display control unit moves the operation element at a constant speed over the predetermined required moving time from the designated arbitrary position to a moving start position which is a position of the operation element before the designation or a predetermined setback position.

In the level adjustment apparatus described above, it is preferable that the apparatus further have an individual required moving time setting unit which sets individually a first required moving time which is the required moving time needed for the movement from the moving start position to the arbitrary position and a second required moving time which is the required moving time needed for the movement from the arbitrary position to the moving start position or a predetermined setback position. It is also preferable that the display control unit move the operation element from the moving start position to the arbitrary position over the first required moving time set by the individual required moving time setting unit, and move the operation element from the arbitrary position to the moving start position or the setback position over the second required moving time.

Another level adjustment apparatus of the invention has: a display unit which displays through a GUT an operation member capable of adjusting an output level by moving an operation element along a predetermined track on a touch panel having a display function, an operation unit which operates the operation element with the touch panel having the display function; a display control unit which performs a display control of the display unit based on an operation of the operation unit; and a level control unit which controls the output level so as to change the output level at a constant rate based on a position of the operation element displayed on the display unit with the display control of the display control unit. When an arbitrary position on the track is designated by the operation unit as a point, the display control unit moves the operation element at a predetermined moving speed from a moving start position which is a position of the operation element before the designation to the designated arbitrary position.

In the level adjustment apparatus described above, it is preferable that the apparatus further have an operation mode setting unit which sets either one of the modes among either two or more operation modes, where a first operation mode which sets back the operation element to the moving start position, a second operation mode which sets back the operation element to a predetermined setback position and a third operation mode which keeps the operation element at the arbitrary position when the designation of the operation element is released by the operation unit. It is also preferable that the display control unit perform a display control based on a setting of the operation mode setting unit.

A signal processing apparatus of the invention has each unit in the level adjustment apparatus described above; an input unit which is capable of receiving a plurality of signals to be adjusted targets of the output level; and an output unit which outputs the signals based on the output level controlled by the level control unit. The display control unit displays operation members corresponding to the number of signals input on the display unit.

An AV processing apparatus of the invention has each unit in the signal processing apparatus described above, and the signals are audio signals or video signals.

A program of the invention is to function a computer as each unit in the level adjustment apparatus described above.

In the level adjustment apparatus described above, it is preferable that the apparatus further have a required moving time setting unit which sets the required moving time, and the display control unit move the operation element from the arbitrary position to the moving start position or the setback position over the required moving time set by the required moving time setting unit.

In the above described level adjustment apparatus, it is preferable that the apparatus further have a setback position setting unit which sets a setback position.

In the level adjustment apparatus described above, it is preferable that the apparatus further have an individual moving speed setting unit which sets individually a first moving speed which is a moving speed from the moving start position to the arbitrary position and a second moving speed which is a moving speed from the arbitrary position to the moving start position or a predetermined setback position. It is also preferable that the display control unit move the operation element from the moving start position to the arbitrary position at the first moving speed, and move the operation element from the arbitrary position to the moving start position or the setback position at the second moving speed.

It may be possible to configure as follows.

A level adjustment apparatus of the invention has: a display unit which displays through a GUT an operation member capable of adjusting an output level by moving an operation element along a predetermined track on a touch panel having a display function; an operation unit which operates the operation element with the touch panel having the display function; a display control unit which performs a display control of the display unit based on an operation of the operation unit; and a level control unit which controls the output level based on a position of the operation element displayed on the display unit with the display control of the display control unit. When an arbitrary position on the track is designated by the operation unit as a point, the display control unit moves the operation element at a constant speed from a moving start position which is a position of the operation element before the designation to the designated arbitrary position over a predetermined required moving time.

With this configuration, as the operation member is operated with the touch panel having the display function, it is possible to adjust the output level easily and intuitively. Further, by designating the arbitrary position on the track of the operation member as a point, the operation element is moved at a constant speed from the moving start position which is a position of the operation element before the designation to the designated arbitrary position over the predetermined required moving time, resulting in a moving speed constant. In other words, the operation element is not actually moved as a mechanical operation member, but is moved to the arbitrary position only with a touch by a user. Therefore, it is easy to operate and an output level adjustment which can not be performed by the mechanical operation member can be achieved.

In the level adjustment apparatus as described above, it is preferable that the required moving time be set to 0, and the display control unit move the operation element from the moving start position to the arbitrary position instantaneously.

When the mechanical operation member is moved, its' moving speed is limited. With this configuration, it is possible to move the operation element to the designated arbitrary position instantaneously.

In the level adjustment apparatus described above, it is preferable that the apparatus further have a required moving time setting unit which sets the required moving time, and the display control unit move the operation element from the moving start position to the arbitrary position over the required moving time set by the required moving time setting unit.

With this configuration, it is possible to move the operation element from the moving start position to the arbitrary position over the required moving time which the user desires. At this time, if the required moving time is set to 0, it is possible to move the operation element instantaneously. Further, if the required moving time is set to a longer time such as 60 seconds, it is possible to achieve a slow constant movement which the mechanical operation member can not achieve.

In the level adjustment apparatus described above, it is preferable that the operation element is moved at a constant speed from the arbitrary position to a predetermined setback position over the required moving time when the designation of the operation element is released by the operation unit

With this configuration, even when the designation of the operation element is released (a finger of the user takes off from the touch panel having the display function), as the operation element is moved at a constant speed from the moving start position or the predetermined setback position over the required moving time, the moving speed is stable.

In the level adjustment apparatus described above, it is preferable that the apparatus further have an individual required moving time setting unit which sets individually a first required moving time which is the required moving time from the moving start position to the arbitrary position and a second required moving time which is the required moving time from the arbitrary position to the moving start position or a predetermined setback position. It is also preferable that the display control unit move the operation element from the moving start position to the arbitrary position over the first required moving time set by the individual required moving time setting unit, and move the operation element from the arbitrary position to the moving start position or the setback position over the second required moving time.

With this configuration, it is possible to move the operation element from the moving start position to the arbitrary position, or from the arbitrary position to the moving start position or the setback position over the required moving time which the user desires.

According to another aspect of the invention, there is provided a level adjustment apparatus having: a display unit which displays through a GUI an operation member capable of adjusting an output level by moving an operation element along a predetermined track on a touch panel having a display function; an operation unit which operates the operation element with the touch panel having the display function; a display control unit which performs a display control of the display unit based on an operation of the operation unit; and a level control unit which controls the output level based on a position of the operation element displayed on the display unit with the display control of the display control unit. When an arbitrary position on the track is designated by the operation unit as a point, the display control unit moves the operation element at a predetermined moving speed from a moving start position which is a position of the operation element before the designation to the designated arbitrary position.

With this configuration, as the operation member is operated with the touch panel having the display function, the output level can be adjusted easily and intuitively. Also, by designating the arbitrary position on the track of the operation member as a point, the operation element is moved at a constant speed from the moving start position which is a position of the operation element before the designation to the designated arbitrary position at a predetermined moving speed, resulting in a moving speed constant. In other words, the operation element is not actually moved as a mechanical operation member, but is moved to the arbitrary position only with a touch by a user. Therefore, it is easy to operate and an output level adjustment which can not be performed by the mechanical operation member can be achieved.

Note that the “predetermined moving speed” may be set by the apparatus or by the user.

In the level adjustment apparatus described above, it is preferable that the apparatus further have an operation mode setting unit which sets either one of the modes, where a first operation mode that sets back the operation element to the moving start position, a second operation mode that sets back the operation element to a predetermined setback position and a third operation mode that keeps the operation element at the arbitrary position when the designation of the operation element is released by the operation unit. It is also preferable that the display control unit perform a display control based on a setting of the operation mode setting unit.

With this configuration, it is possible to set a motion (operation mode) in correspondence to the user's preference when the designation of the operation element is released.

A signal processing apparatus of the invention has each unit in the level adjustment apparatus described above; an input unit which is capable of receiving a plurality of signals to be adjusted targets of the output level; and an output unit which outputs the signals based on the output level controlled by the level control unit. The display control unit displays operation members corresponding to the number of signals input on the display unit.

With this configuration, the adjustment of the output level of the input signal can be performed by an intuitive operation, which can not be achieved by a mechanical operation member and it is possible to output a signal corresponding to the adjusted output level. Also, when a signal processing apparatus which is capable of receiving a number of signals is used, the operation members corresponding to the number of input signals, unnecessary operation members are not displayed, keeping high operability.

An AV processing apparatus of the invention has each unit in the signal processing apparatus described above, and the signals are audio signals or video signals.

With this configuration, though an AV processing apparatus performing an edit processing of the audio signals and the video signals are generally desired to have intuitive operability and realize various musical and video image expressions, it is possible to provided comfortable operations to a user dealing with the AV processing apparatus by adapting the invention.

A program of the invention is to function a computer as each unit in the level adjustment apparatus described above.

By implementing the program, it is possible to provide the level adjustment apparatus which can perform the adjustment of the output level by an intuitive operation, which can not be achieved with a mechanical operation member.

### BRIEF DESCRIPTION OF THE DRAWINGS

FIG. 1A is a system configuration diagram of an AV processing system according to an embodiment of the invention, and FIG. 1B is a simplified configuration diagram of the AV processing apparatus.

FIG. 2 is a diagram of a user interface provided in the AV processing apparatus.

FIG. 3 is a block diagram of the AV processing apparatus.

FIG. 4A and FIG. 4B are diagrams showing display controls when an arbitrary point on a track of an operation member is designated.

FIGS. 5A, 5B and 5C are explanatory views of operation modes.

FIGS. 6A and 6B are diagrams showing other display examples of a touch panel.

### REFERENCE NUMERALS

10 CD player
20 DVD player
30 AV processing apparatus
31 CPU
32 GUI drawing unit
33 level control unit
35 rotary controller
36 operation mode setting button
40 speaker
50 monitor
61 operation element
62 track
F linear type fader
FR rotary type fader
TP touch panel

### BEST MODES FOR CARRYING OUT THE INVENTION

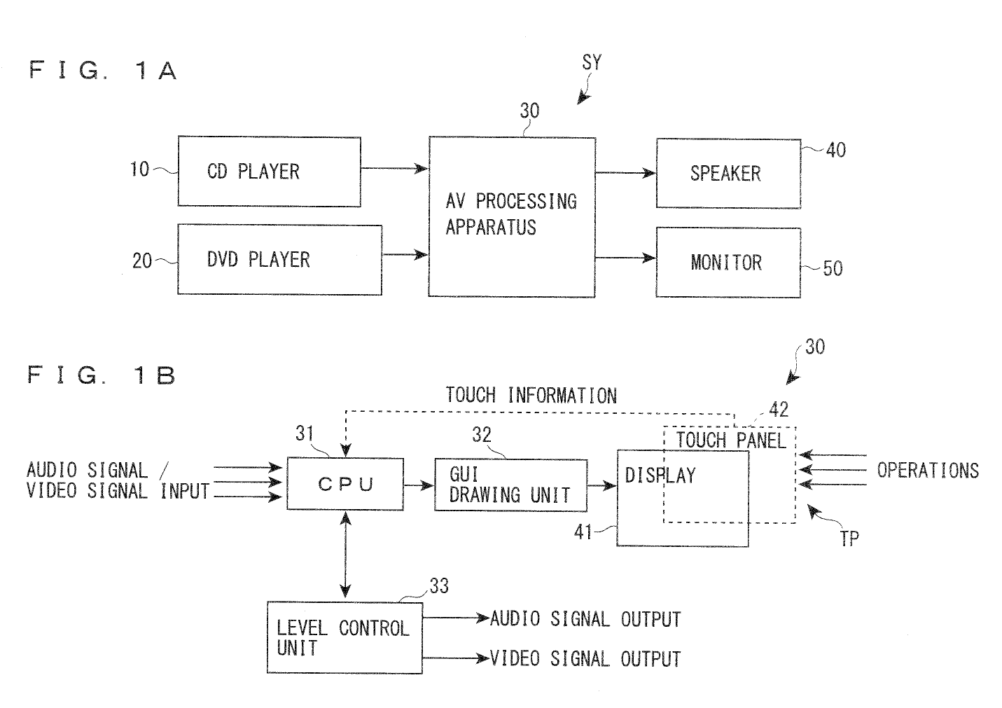

A level adjustment apparatus, a signal processing apparatus, an AV processing apparatus and a program therefor according to an embodiment of the invention will be explained with reference to accompanying drawings. FIG. 1A is a system configuration diagram of an AV processing system SY adapted with the AV processing apparatus of the invention. The AV processing system SY has: one or more CD players 10 (only one CD player is shown in FIG. 1A) which generate one or more audio signals to be input to an AV processing apparatus 30; one or more DVD players 20 (only one DVD player is shown in FIG. 1A) which generate one or more video signals to be input to the AV processing apparatus 30; the AV processing apparatus 30 which is input with one or more audio and/or video signals (audio and/or video signals are referred as an “AV signal” hereinafter) from one or more CD players 10 and/or DVD players 20 and which edits these signals to generate output AV signals; a speaker 40 which outputs the audio signal output from the AV processing apparatus 30; and a monitor 50 which displays the video signal output from the AV processing apparatus 30.

The AV processing apparatus 30 of the embodiment is capable of receiving a plurality of AV signals and performs various edit processing such adjustments of output levels (for example, sound volume of audio signals or a parameter such a luminance factor in video signals). One example of the AV processing apparatus 30 is DVJ equipment used in a club or the like (composite equipment of DJ equipment used for audio performance by disc jockeys (DJs) and VJ equipment used for video performance by visual jockeys or video jockeys (VJs)) which is capable of dealing with the audio signals and/or the video signals and which applies effects and the like to both of sounds and videos as if users feel the equipment as an instrument.

VJs and DJs will be explained hereinbelow. VJs mix (synthesize or join) videos in accordance with music extemporaneously. While DJs mix music extemporaneously, VJs perform using videos. VJs perform to switch and output videos on a screen or the like mainly in an event or a club party, and select appropriate videos extemporarily in harmony with music being played in a hall or project progress and show the videos in good timing.

In contrast, DJs select musical compositions depending on the atmosphere of the venue, and play the musical compositions seamlessly. They use, for example, turntables for their performance, with which they can change the pitch (speed) of musical compositions. Performance other than selecting musical compositions, they commonly perform DJ mixing and scratching, for example. During the mixing, they connect the music currently being played and the music to be played next smoothly without any break of sounds to maintain the tension of the floor.

VJs and DJs generally perform separately under the present circumstances. Most of them specialize in performance of either music or videos. Since each has a specialized field, it is difficult for them to mix objects beyond their specialized fields. Even having one object, VJs and DJs are very busy to perform various operations such as joining objects extemporaneously and applying effects. Therefore, they cannot afford to handle both objects.

However, both the performance requires performers to change and output musical compositions and videos depending on the atmosphere in the hall or performers own feelings. Since sounds and videos need to be provided in harmony with each other, it is desirable for one person to perform both performance. Even VJs who are good at processing videos can handle music easily in addition to videos if music changes as videos change. On the other hand, DJs who are dedicated to acoustic performance can also handle both sounds and videos more naturally if videos change as sounds change.

The AV processor 30 according to this embodiment makes it possible for one person to handle music and videos simultaneously, which has been practically impossible. Simple and comfortable operations are provided to a person who tries to handle both music and videos.

As apparatuses for generating AV signals input to the AV processing apparatus 30, other apparatuses (such as various types of audio equipment, video equipment, and personal computers) can be used, without limited to the CD player 10 or the DVD player 20. Functions of the CD player 10 or the DVD player 20 may be installed in the AV processor 30. Further, the video signals may be for animations or still images.

FIG. 1B is a simplified configuration diagram of the AV processing apparatus 30. The AV processing apparatus 30 has a touch panel TP with a display function, a CPU 31, a GUI drawing unit 32 and a level control unit 33 as main structure elements.

The touch panel TP having the display function includes a display 41 having a display element such as a TFT, and a touch panel 42 superposed thereon. As the user can operate the touch panel 42 on display of the display 41 by adopting the touch panel TP having the display function (refereed to as a “touch panel TP” hereinafter), simple and intuitive operations can be made.

The CPU 31 detects a position and a movement of an operation position according to a voltage change (touch information) based on an operation (touch) on the touch panel TP. Further, the CPU 31 generates display control signals used for a display control of the touch panel TP (the display 41) and level control signals used for level adjustments based on the detected results to output the respective signals to the GUI drawing unit 32 and the level control unit 33. Still further, the CPU 31 performs integral controls for the AV processing apparatus 30 such as information management based on user's operations with various operation elements and input/output of signals from/to external devices.

The GUI drawing unit 32 displays through a GUI on the touch panel TP based on the display control signals input from the CPU 31 and the number of AV signals input. Further, the level control unit 33 is generally configured with an audio/video control device, controls output levels of the input signals based on level control signals input from the CPU 31, and generates output audio signals and/or video signals based on the control results. Still further, the level control unit 33 outputs these generated signals from respective output interfaces.

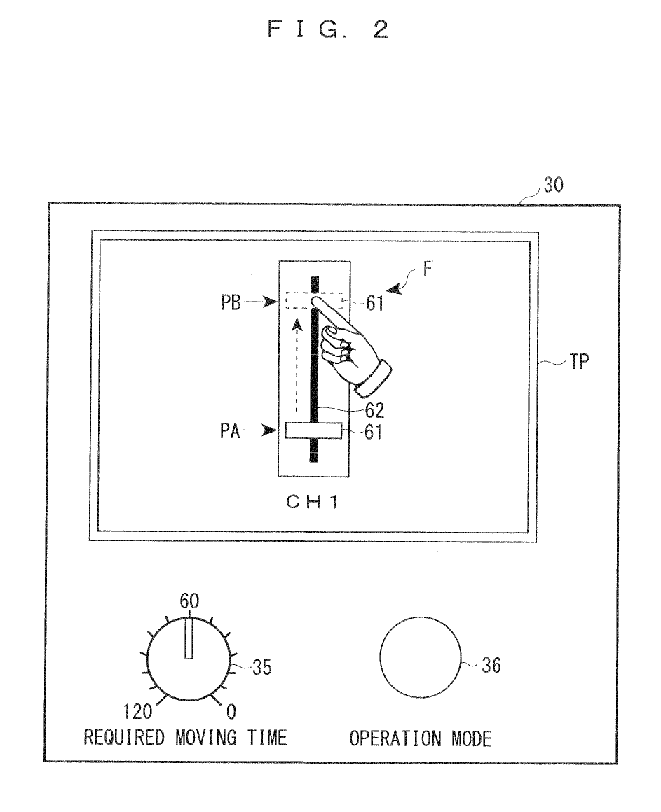

Referring to a plan view of FIG. 2, a user interface provided in the AV processing apparatus 30 will be explained. As shown in FIG. 2, the AV processing apparatus 30 has the above described touch panel TP, a rotary controller (knob) 35 and a operation button 36 on a top surface of a case thereof. The AV processing apparatus 30 has, as other user interfaces, a confirmation display by which the user can confirm video images of the video signals included in the output AV signals and various operation elements and the like which switch the input AV signals and set effect on the input AV signals (not shown).

The touch panel TP displays operation elements according to the number of input AV signals. FIG. 2 shows a display example where the AV signal is input in only CH 1 and a linear type fader F is adopted as an operation element.

As shown in the example of FIG. 2, the fader F has an operation element 61 and a track 62 which is a moving path of the operation element 61. An output level of the CH 1 can be adjusted when the user moves the operation element 61 along the track 62. When the operation element 61 positions at a position PA (moving start position) for example and a position PB (arbitrary position) is designated (touched), the fader F can move the operation element 61 at a constant speed over a predetermined (pre-set) required moving time from the position PA to the position PB. If a fader is provided physically, there is no operation method for the operation element 61 except that the operation element 61 is moved (dragged) along the track 62. On the other hand, as shown in the embodiment, the operation element 61 can be operated with an operation in which a “point” is designated by a touch on the track 62 by implementing the fader F displayed through a GUI. As the operation element 61 moves at a constant speed from the position PA to the position PB, a moving speed is stable. For example, in a case that a sound volume of the audio signal is adjusted, a smooth audio volume control can be achieved without giving a sense of discomfort to audience.

The rotary type controller 35 is configured to set the required moving time needed for moving the operation element 61 from the position PA to the position PB. In the embodiment, the required moving time can be set between 0 second to 120 seconds by rotating the rotary type controller 35. In a case that the required moving time is set at 60 seconds, the operation element 61 moves slowly from the position PA to the position PB and it reaches at the position PB after 60 seconds. The speed is constant as a “distance from the position PA to the position PB/60 seconds”. Thus, when a fader operation is performed slowly, it is not possible to move the operation element 61 at a constant speed with a finger. In this preferred embodiment, such an operation can be performed easily.

An amount of change by a rotation of the rotary type controller 35 may not increase/decrease linearly (may not increase/decrease at a constant rate regardless of a position of the rotary type controller 35), but may be set to increase by quadric curve (the closer the rotary type controller 35 reaches to the maximum value, the bigger the change rate becomes). According to the configuration, a fine setting within a range where the required moving time is short (around the minimum value) is easily made.

The operation button 36 is an operation mode setting button which sets either one of the three operation modes performing different motions one another when a designation of the operation element 61 is released (when the finger takes off from the touch panel TP). In the embodiments in a case that a first operation mode is set, when the designation of the operation element 61 of the fader F is released, the operation element 61 is set back to the moving start position. In a case that a second operation mode is set, when the designation of the operation element 61 of the fader F is released, the operation element 61 is set back to a predetermined setback position. Further, in a case that a third operation mode is set, when the designation of the operation element 61 of the fader F is released, the operation element 61 is kept at a designated (arbitrary) position. Note that a detail of each operation mode will be explained later with an example.

Settings for the required moving time and the operation mode may be performed with other operation elements such as arrow keys or a joy-stick other than the above rotary type controller or the operation button.

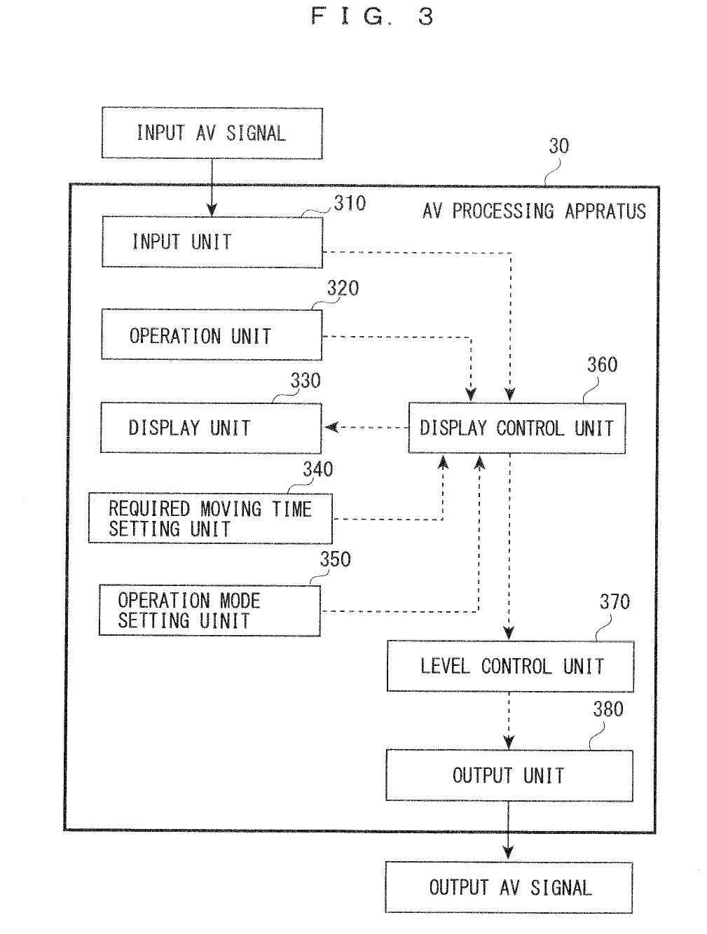

Referring to a block diagram shown in FIG. 3, a control configuration of the AV processing apparatus 30 will be explained. As shown in FIG. 3, the AV processing apparatus 30 has an input unit 310, an operation unit 320, a display unit 330, a required moving time setting unit 340, an operation mode setting unit 350, a display control unit 360, a level control unit 370 and an output unit 380.

The input unit 310 is used to receive a plurality of AV signals (input AV signals) and is configured with signal input interfaces (such as a USB and a MIDI) (not shown) as main elements. The operation unit 320 and the display unit 330 are configured with the touch panel TP as main elements. The operation unit 320 adjusts the output level of a signal corresponding to an operation member with an operation of the operation element 61 of the operation member (fader F) displayed on the touch panel TP by the user. The display unit 330 displays the operation member through a GUI.

The required moving time setting unit 340 is used to set the required moving time needed for moving the operation element 61 from the moving start position which is a position of the operation element 61 before the arbitrary position is designated as a point to the designated arbitrary position when the arbitrary position on the track 62 of the operation member is designated as a point by the operation unit 320. The required moving time setting unit 340 is configured with the above rotary type controller 35 (refer to FIG. 2) as a main element. The operation mode setting unit 350 is used to set a motion of the operation element 61 when the designation of the operation element 61 is released by the operation unit 320, and is configured with the above operation mode setting button 36 (refer to FIG. 2) as a main element.

The display control unit 360 is used to perform a display control of the display unit 330 such that an operation result of the operation unit 320 is reflected to the display unit 330 based on the operation of the operation unit 320, and is configured with the above CPU 31 and the GUI drawing unit 32 (refer to FIG. 1B) as main elements. The display control unit 360 moves the operation element 61 according to a manual speed when the operation element 61 is dragged along the track 62. When the arbitrary position on the track 62 is designated, the display control unit 360 moves the operation element 61 to the arbitrary position at a constant speed over the required moving time set by the required moving time setting unit 340.

The display control unit 360 performs a display control based on a setting of the operation mode setting unit 350 when the designation of the operation element 61 is released. Especially, in the case that the first operation mode is set (in the case of the setting where the operation element 61 is set back to the moving start position when the designation of the operation element 61 is released) or that the second operation mode is set (in the case of the setting where the operation element 61 is set back to the predetermined setback position when the designation of the operation element 61 is released), the operation element 61 is moved at a constant speed from the arbitrary position to the moving start position or the setback position by over the required moving time set by the required moving time setting unit 340.

The level control unit 370 is used to control the output level of a signal corresponding to an operation member based on a position of the operation element 61 of the operation member displayed on the display unit 330 by a display control of the display control unit 360, and is configured with the above CPU 31 and the level control unit 33 (refer to FIG. 1B) as main elements. The output unit 380 is used to output an AV signal (output AV signal) based on the output level controlled by the level control unit 370 and is configured with the signal output interfaces (such as the USB and the MIDI) (not shown).

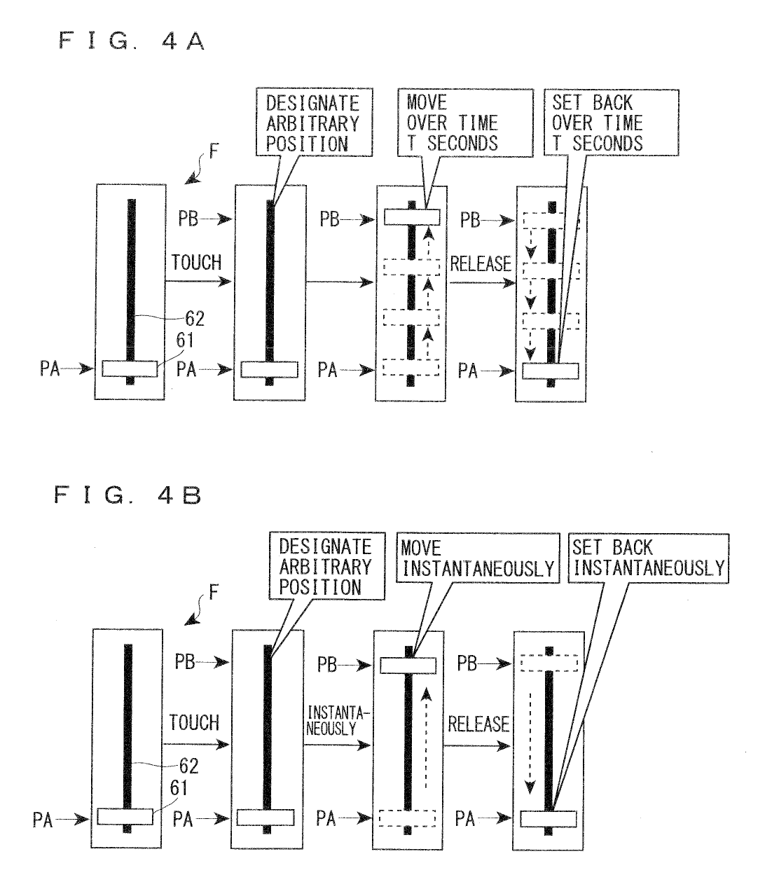

Referring to FIG. 4A and FIG. 4B, a display control when an arbitrary position on the track 62 of the operation member (fader F) is designated as a point will be explained. Note that the explanation will be made in the first operation mode (the mode in which the operation element 61 is set back to the moving start position when the designation of the operation element 61 is released).

As shown in FIG. 4A, in a case that the required moving time is set at t seconds (t>0 second), when the arbitrary position PB is designated (touched by the user) in a state that the operation element 61 positions at the moving start position PA, the operation element 61 moves from the moving start position PA to the arbitrary position PB at a constant speed over the time t seconds. When the designation of the operation element 61 is released from a state where the operation element 61 positions at the arbitrary position PB, the operation element 61 is also set back from the arbitrary position PB to the moving start position PA at a constant speed over the time t seconds.

As shown in FIG. 4B, in a case that the required moving time is set at 0 second, when the arbitrary position PB is designated in the state that the operation element 61 positions at the moving start position PA, the operation element 61 moves from the moving start position PA to the arbitrary position PB instantaneously. When the designation of the operation element 61 is released from the state where the operation element 61 positions at the arbitrary position PB, the operation element 61 is also set back to the moving start position PA from the arbitrary position PB instantaneously.

Thus, the user can move the operation element 61 over a desired time frame or instantaneously by designating an arbitrary position on the track 62 of the fader F as a point. Further, the operation element 61 can be set back to the operation start position over the desired time frame or instantaneously by releasing the designation thereof.

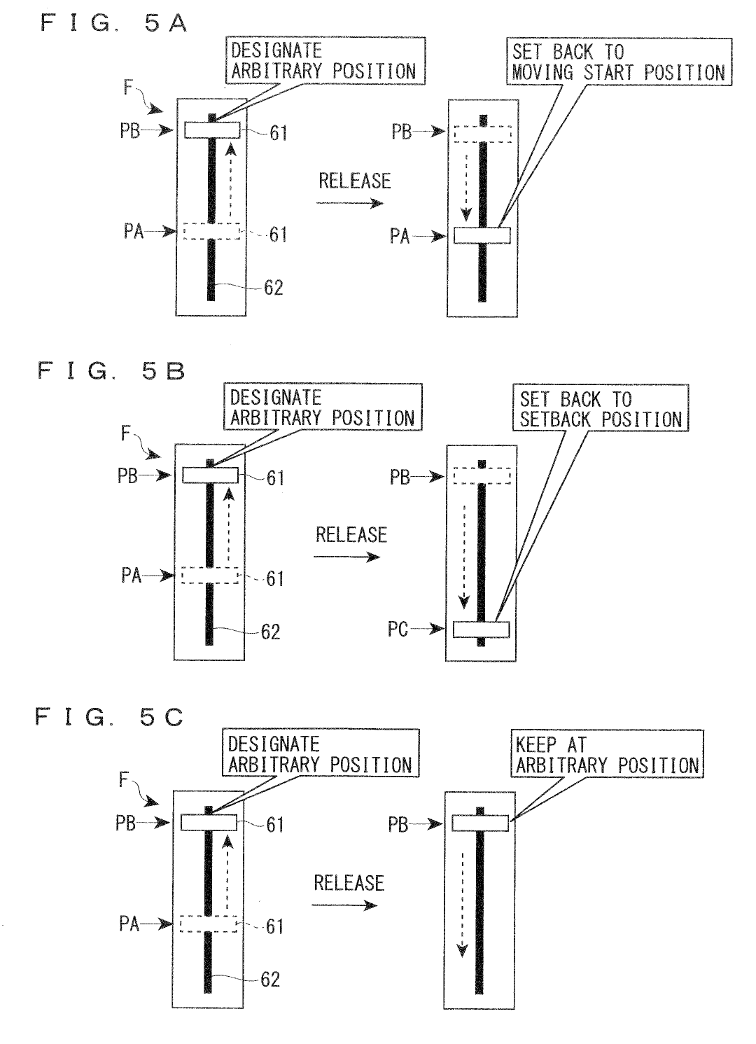

Referring to FIGS. 5A to FIG. 5C, each operation mode will be explained. FIGS. 5A to 5C show cases in which the operation element 61 moves from the moving start position PA to the arbitrary position PB designated as a point, and then it is released. The required moving time is supposed to be set at t seconds. As shown in FIG. 5A, when the first operation mode is set, the operation element 61 is set back to the moving start position PA after the user releases the designation. As stated above, a movement from the arbitrary position PB to the moving start position PA needs the t seconds.

As shown in FIG. 5B, when the second operation mode is set, the operation element 61 is set back to a predetermined setback position PC after the user releases the designation. Also in this case, a movement from the arbitrary position PB to the setback position PC needs the t seconds. Therefore, moving speeds of the setbacks in the first operation mode and the second operation mode are different each other (in the examples shown in FIGS. 5A and 5B, the moving speed in the second mode is faster than that in the first mode). The setback position PC may be set preliminary or may be set by a predetermined operation by the user.

On the other hand, as shown in FIG. 5C, when the third operation mode is set, the operation element 61 is kept at the predetermined position PB. Therefore, in the case that the third operation mode is set, the setting of the required moving time does not affect thereto.

Thus, the user can set an operation mode as the user desires. The setting of the operation mode may be performed by switching the operation modes with designating method of an arbitrary position rather than by setting fixedly by the operation of the operation mode setting button 36. For example, in a case that an arbitrary position is designated by a single click, the operation element 61 may set back to the moving start position based on the first operation mode, and in a case that the arbitrary position is designated by a double click, the operation element 61 may be kept at the arbitrary position based on the third operation mode.

An operation mode may be adapted not only when an arbitrary position on the track 62 of the fader F is designated as a point but also when the operation element 61 is moved manually. In other words, when the finger of the user is set apart from the touch panel TP after the user performs a dragging operation on the operation element 61, the operation element 61 may act based on each operation mode. Further, it may be possible to set an operation mode according to user's preference whether an operation mode is adapted only when an arbitrary position is designated as a point, whether the operation mode is adapted only when the operation element 61 is operated manually, or whether the operation mode is adapted in the above two cases.

As described above, according to the embodiment, as the operation member is operated with the touch panel TP, an output level can be adjusted simply and intuitively. Further, by designating an arbitrary position on the track of the operation member as a point, the operation element is moved at a constant speed over the predetermined required moving time from the moving start position which is a position of the operation element 61 before the arbitrary position is designated as a point to the designated arbitrary position. Therefore, a moving speed is constant and an adjustment of the output level which can not be achieved by a mechanical operation member can be performed. Further, the required moving time can be set according to the user's preference or needs. For example, when the required moving time is set at 0 second, it is possible to move the operation element 61 instantaneously. When the required moving time is set at a longer time such as 60 seconds, it is possible to achieve a low-speed constant movement can be achieved, which can not be achieved by the mechanical operation member. Thus, the AV processing apparatus 30 in the embodiment can implement an adjustment of the output level originally and can be effective to various video image expressions and musical expressions.

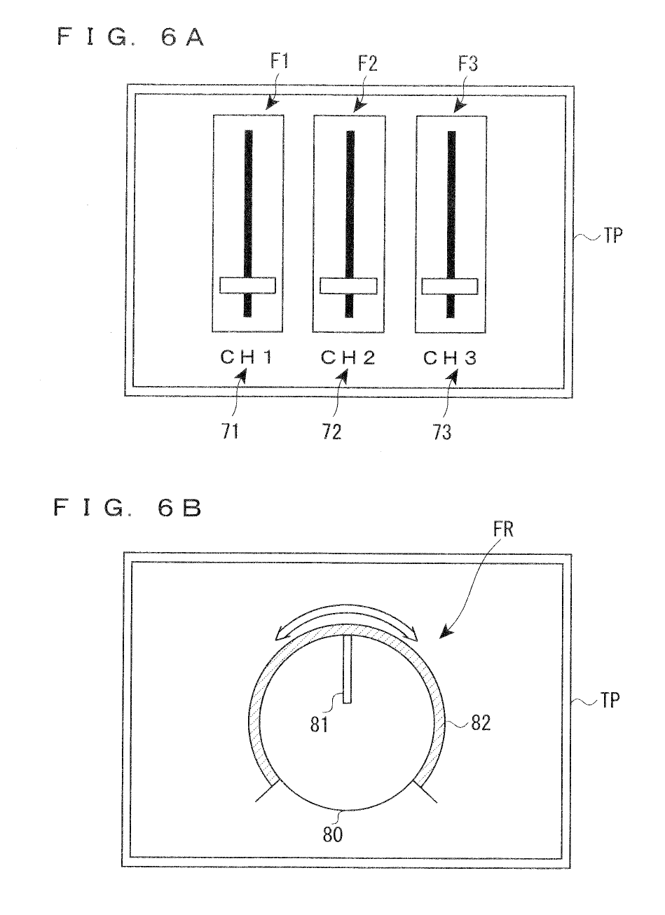

In the above embodiment, though the example in which only one operation member (fader F) is displayed on the touch panel TP is shown (refer to FIG. 2), operation members corresponding to the number of signals input may be displayed on the touch panel TP. FIG. 6A shows a display example of the touch panel TP when three signals of CH 1 to CH 3 are inputted. Thus, when the three signals of CH 1 to CH 3 are input, three faders F1 to F3 corresponding to respective signals are displayed and displays (“CH 1” to “CH 3”) 71 to 73 showing corresponding channels are displayed. According to this configuration, operation members in correspondence with the number of signals input are displayed. Therefore, even when the AV processing apparatus 30 which is capable of receiving a number of signals, unnecessary operation members are not shown, without letting its' operability lower.

It is preferable that each operation member be provided on the touch panel TP based on the number of signals input to provide it in an appropriate position. In this case, it is preferable to provide each operation member according to signal types or parameters which are used to adjust output levels while operability is considered.

Further, in the above embodiment, though the linear type fader F is displayed as an operation member, a rotary type fader FR may be used. FIG. 6B shows an example of the rotary type fader FR. In a case that the rotary type fader FR is used, an operation element is a knob 80. A “position of the operation element” corresponds to a position of a reference mark 81 provided on the knob 80. When the rotary type fader FR is used, a track 82 is a circular form (having a portion of a non-operable area as shown in FIG. 6B).

If an operation member is capable of adjusting the output levels by moving the operation element along a predetermined track, various forms of operation members (controllers) can be adapted except the above linear type fader F and the rotary type fader FR.

Further in the above embodiment, for example, in the first setting mode, though the operation element moves from a moving start position to an arbitrary position over a required moving time set and sets back from the arbitrary position to the moving start position over the required moving time set, it may be possible to set different required moving times in outward and homeward paths to the arbitrary position (an individual required moving time setting unit). According to this configuration, the operation element 61 can be moved from the moving start position to the arbitrary position or from the arbitrary position to the moving start position over a required moving time which the user desires. In the case of the second setting mode, it may be possible to set different required moving times in the outward path to the arbitrary position (from the moving start position to the arbitrary position) and the homeward path (from the arbitrary position to the setback position).

Further, in the above embodiment, the required moving time can be set, instead, it may be possible to set a moving speed of the operation element 61 from the moving start position to the arbitrary position. According to this configuration, as the moving speed of the operation element 61 can be designated directly, the user can assume a change of output values readily. It may be also possible to set different moving speeds for the movement in the outward path to the arbitrary position and in the homeward path.

Still further, though the DVJ equipment used in a club and the like is exemplified as the AV processing apparatus 30, the invention can be adapted to an apparatus and a program (such as an audio/video mixer, an audio/video controller, an audio/video processing application) other than the DVJ equipment. In other words, the invention can be adapted to an apparatus which processes only audio signals or only video signals except an apparatus dealing with both audio and video signals.

Also, each unit and function included in the AV processing apparatus 30 described in the example above can be provided as a program. The program can also be stored and provided in a recording medium (not shown). Examples of such recording medium include: a CDROM, a flash ROM, a memory card (i.e., a compact flash (trade mark), a smart media, a memory stick), a compact disc, a magneto-optical disc, a digital versatile disc, a flexible disc, and a hard disc.

The configuration, the processing steps, and the like may not be limited to the above-described embodiments, but may be modified suitably within the spirit and scope of the present invention. For example, input signals may be other signals other than audio signals or video signals, and a level adjustment apparatus without the input unit 310 and the output unit from the AV processing apparatus 30 is within a scope of right of the invention.

1-10. (canceled)

11. A level adjustment apparatus comprising:
a display unit that displays through a GUI an operation member capable of adjusting an output level by moving an operation element along a predetermined track on a touch panel having a display function;
an operation unit that operates the operation element with the touch panel having the display function;
a display control unit that performs a display control of the display unit based on an operation of the operation unit; and
a level control unit that controls the output level so as to change the output level at a constant rate based on a position of the operation element displayed on the display unit with the display control of the display control unit;
wherein, when an arbitrary position on the track is designated by the operation unit as a point, the display control unit moves the operation element at a constant speed from a moving start position which is a position of the operation element before the designation to the designated arbitrary position over a predetermined required moving time.

12. The level adjustment apparatus according to claim 11, further comprising a required moving time setting unit that sets the required moving time, wherein the display control unit moves the operation element from the moving start position to the arbitrary position over the required moving time set by the required moving time setting unit.

13. A level adjustment apparatus comprising:
a display unit that displays through a GUI an operation member capable of adjusting an output level by moving an operation element along a predetermined track on a touch panel having a display function;
an operation unit that operates the operation element with the touch panel having the display function;
a display control unit that performs a display control of the display unit based on an operation of the operation unit; and
a level control unit that controls the output level so as to change the output level at a constant rate based on a position of the operation element displayed on the display unit with the display control of the display control unit;
wherein, when an arbitrary position on the track is designated by the operation unit as a point and is released, the display control unit moves the operation element at a constant speed from the designated arbitrary position to a moving start position which is a position of the operation element before the designation or a predetermined setback position over a predetermined required moving time.

14. The level adjustment apparatus according to claim 11, further comprising an individual required moving time setting unit that sets individually a first required moving time that is the required moving time needed for the movement from the moving start position to the arbitrary position and a second required moving time that is the required moving time needed for the movement from the arbitrary position to the moving start position or a predetermined setback position;
wherein the display control unit moves the operation element from the moving start position to the arbitrary position over the first required moving time set by the individual required moving time setting unit, and moves the operation element from the arbitrary position to the moving start position or the setback position over the second required moving time.

15. A level adjustment apparatus comprising:
a display unit that displays through a GUI an operation member capable of adjusting an output level by moving an operation element along a predetermined track on a touch panel having a display function;
an operation unit that operates the operation element with the touch panel having the display function;
a display control unit that performs a display control of the display unit based on an operation of the operation unit; and
a level control unit that controls the output level so as to change the output level at a constant rate based on a position of the operation element displayed on the display unit with the display control of the display control unit;
wherein, when an arbitrary position on the track is designated by the operation unit as a point, the display control unit moves the operation element at a predetermined moving speed from a moving start position which is a position of the operation element before the designation to the designated arbitrary position.

16. The level adjustment apparatus according to claim 11, further comprising an operation mode setting unit that sets either one of the modes among either two or more operation modes, where a first operation mode that sets back the operation element to the moving start position, a second operation mode that sets back the operation element to a predetermined setback position and a third operation mode that keeps the operation element at the arbitrary position when the designation of the operation element is released by the operation unit, wherein the display control unit performs a display control based on a setting of the operation mode setting unit.

17. A signal processing apparatus comprising:
each unit in the level adjustment apparatus according to claim 1;
an input unit that is capable of receiving a plurality of signals to be adjusted targets of the output level; and
an output unit that outputs the signals based on the output level controlled by the level control unit;
wherein the display control unit displays operation members corresponding to the number of signals input on the display unit.

18. An AV processing apparatus comprising each unit in the signal processing apparatus according to claim 17, wherein the signals are audio signals or video signals.

19. A program functioning a computer as each unit in the level adjustment apparatus according to claim 11.

20. The level adjustment apparatus according to claim 13, further comprising a required moving time setting unit that sets the required moving time, wherein the display control unit moves the operation element from the arbitrary position to the moving start position or the setback position over the required moving time set by the required moving time setting unit.

21. The level adjustment apparatus according to claim 13, further comprising a setback position setting unit that sets the setback position.

22. The level adjustment apparatus according to claim 15, further comprising an individual moving speed setting unit that sets individually a first moving speed which is a moving speed from the moving start position to the arbitrary position and a second moving speed which is a moving speed from the arbitrary position to the moving start position or a predetermined setback position, wherein the display control unit moves the operation element from the moving start position to the arbitrary position at the first moving speed, and moves the operation element from the arbitrary position to the moving start position or the setback position at the second moving speed.
